(19) United States
(12) Patent Application Publication
(10) Pub. No.: US 2026/0330450 A1
(43) Pub. Date: Oct. 22, 2026

(54) Digital Identity and Consent Management System

(71) Applicant: Tracer Labs, Inc., Middleburg, VA (US)

(72) Inventors: Patrick J. MOYNIHAN, Brighton, NY (US); Eddie SATTERLY, Guffey, CO (US)

(21) Appl. No.: 19/468,310

(22) Filed: Feb. 3, 2026

Related U.S. Application Data
(60) Provisional application No. 63/753,155, filed on Feb. 3, 2025.

(51) Int. Cl. G06Q 20/36

(52) U.S. Cl. CPC G06Q 20/3674

(57) ABSTRACT

A digital identity and consent management standard (DICMS), providing a unified, scalable framework for user-driven consent across decentralized, AI, web3 and web4 ecosystems. Leveraging a decentralized infrastructure, cryptographic network protocols, and integrates deferred cryptographic proofs and quantum-resistant encryption to redefine consent validation. This technology disclosed herein introduces a Dynamic Data Transformation Layer (DDTL) that anonymizes and provisions compliant first-party user data for enterprise applications while ensuring secure, ethical data usage. Supporting interoperability across digital spectrums, the framework aligns with global compliance standards like GDPR and CCPA and prepares for future technologies, including Web4 ecosystems and large language models (LLMs). The technology disclosed herein introduces a proof-of-humanity (POH) option under a decentralized autonomous organization (DAO) consent standard, allowing secure user opt-ins for KYC identity claims, data sovereignty, and resource delivery across public and private services.

### CROSS REFERENCE TO RELATED APPLICATIONS

This application is a non-provisional application based on and claims priority to U.S. Provisional Patent Application No. 63/753,155, filed Feb. 3, 2025 and entitled “Digital Identity and Consent Management System,” which is hereby incorporated by reference in its entirety.

### BACKGROUND

In the normal course of business in using any internet site a user is required to accept blanket consent options known as cookies to fully use a website functionality. A site is required due to several global regulations to prompt you to accept cookies and give you the option to opt-out of certain cookie type that collect personally identifiable data. This process is not easy for a normal user to understand the implications and options. One of the most common actions taken by users to click the “allow all” button to just move past the prompt and use the site.

When a user clicks to allow all cookies the site and third parties affiliated with the site begin to collect your personal data, search data and click data for the site and any site you may go to after. This data is then used to actively target your ad display as well as to push specific options and filters to data you see to the benefit of the party who took your data. Many cases have led to people getting only higher priced options and purchasing products that the user does not want or need.

The right to limit how the data is collected and used has been a part of several global regulations such as General Data Privacy Regulation (GDPR) and California Consumer Privacy Act (CCPA) however these rely on the user to know how to opt-out. While it is in the best interest of the user in most cases to opt-out it is in the best interest of the third-party to have you opt-in and therefore the process is made confusing and complex.

### SUMMARY

The technology disclosed herein relates to a digital identity and consent management system (DICMS), and related methods, to provide users with the ability to one time consent and review later at their choice to provide whatever data they wish to share with the third-party. The modular system built into the decentralized wallet infrastructure with methods to empower real-time user consent control, validation, revocation, and privacy management. Traditional intrusive consent workflows, such as cookie pop-ups, are replaced by a method presenting a user-friendly mini dashboard featuring dynamic consent mapping and personalized identity modules.

The system and methods are providing a unified, scalable framework for user-driven consent across decentralized, AI, web3 and web4 ecosystems. Leveraging a decentralized infrastructure, cryptographic network protocols, and integrates deferred cryptographic proofs and quantum-resistant encryption to redefine consent validation.

This Summary is provided to introduce a selection of concepts in a simplified form that are further described below in the Detailed Description. This Summary is not intended to identify key features or essential features of the claimed subject matter nor is it intended to be used to limit the scope of the claimed subject matter.

Other implementations are also described and recited herein.

### BRIEF DESCRIPTIONS OF THE DRAWINGS

FIG. 1 Illustrates an example flowchart of a DICMS workflow

FIG. 2 illustrates an example of a DICMS system and components

FIG. 3 illustrates components of a user's digital Identity profile creation on first access to DCIMS

FIG. 4 illustrates an example of a user consent flow with a third-party

FIG. 5 illustrates some of the processes and the flow of requests from user to system and third-party

FIG. 6 illustrates third-party account linking flow and related services of DICMS

FIG. 7 illustrates User data service profile and some of the data elements under consent control

FIG. 8 illustrates the Dynamic Data Transformation Layer (DDTL) of the data service

FIG. 9 illustrates the Proof of Humanity (POH) capability of the system.

FIG. 10 illustrates an example mobile device that can be used in implementing the technology disclosed herein.

FIG. 11 illustrates an example computing device that can be used in implementing the technology disclosed herein.

### DETAILED DESCRIPTIONS

A digital identity and consent management standard (DICMS), providing a unified, scalable framework for user-driven consent across decentralized, AI, web3 and web4 ecosystems. Leveraging a decentralized infrastructure, cryptographic network protocols, and integrates deferred cryptographic proofs and quantum-resistant encryption to redefine consent validation. This technology disclosed herein introduces a Dynamic Data Transformation Layer (DDTL) that anonymizes and provisions compliant first-party user data for enterprise applications while ensuring secure, ethical data usage. Supporting interoperability across digital spectrums, the framework aligns with global compliance standards like GDPR and CCPA and prepares for future technologies, including Web4 ecosystems and large language models (LLMs). The technology disclosed herein introduces a proof-of-humanity (POH) option under a decentralized autonomous organization (DAO) consent standard, allowing secure user opt-ins for KYC identity claims, data sovereignty, and resource delivery across public and private services.

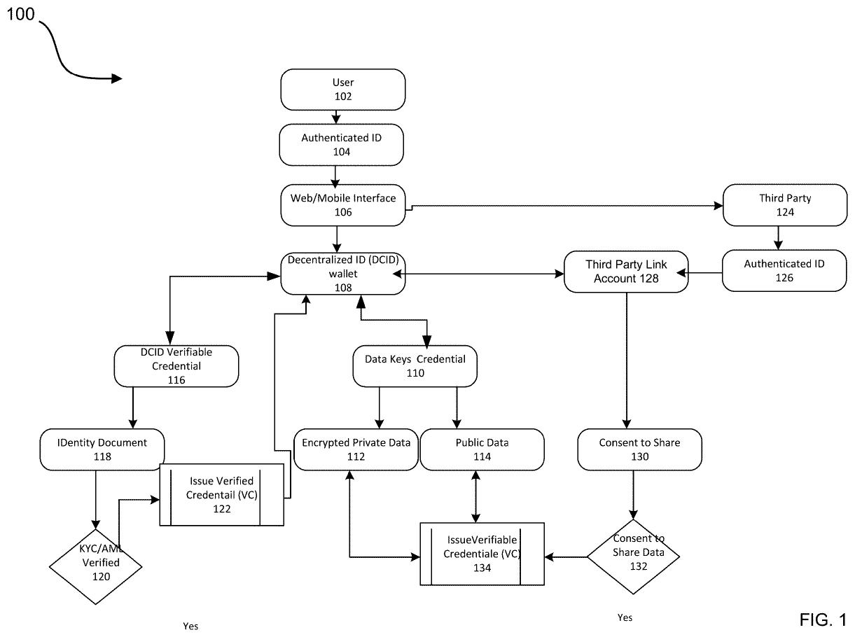

FIG. 1 Illustrates an example flowchart of a DICMS workflow. The User 102 connects to the presentation service of the DCIMS via a web or mobile interface 106 via a user authentication service 104. If the User 102 is creating the account for the first time, then it will create a Digital Consent ID (DCID) wallet 108. Upon creation of a wallet the cryptographic service is called to generate a pair of data credential key 110 and then the data service is called to create an encrypted private data store using generated keys 110 and a public data store 114.

Once the account is verified 116 to the appropriate level with for example a government issued ID 118 and as needed a KYC/AML 120 check then an appropriate DCID Verifiable Credential (VC) 122 will be issued to the user's wallet 108. If a User 102 wants to link an account from a third-party 124 or if in the case of normal use is prompted by a third-party using the DCIMS system, then the account linking flow is called from the issuer service. The User 102 will then login to the third-party 124 system using their existing account or create a new one if required to authenticate 126. This authenticated account will then go through the linking process 128. To link the account 128 the user 102 will be asked to consent to share base required data as well as any third-party requested data 130. The User 102 will be asked to consent to each data element as required and requested by the third-party and has full granular control of the consent request 132. If the user agrees to consent to at least the required data 130 to link the account 128 then a Verifiable Credential (VC) will be issued for the third-party 124 to the User wallet 108. At that time a set of keys will be generated for the third-party 124 to access the specific User's 102 data as granted in the consent request 130.

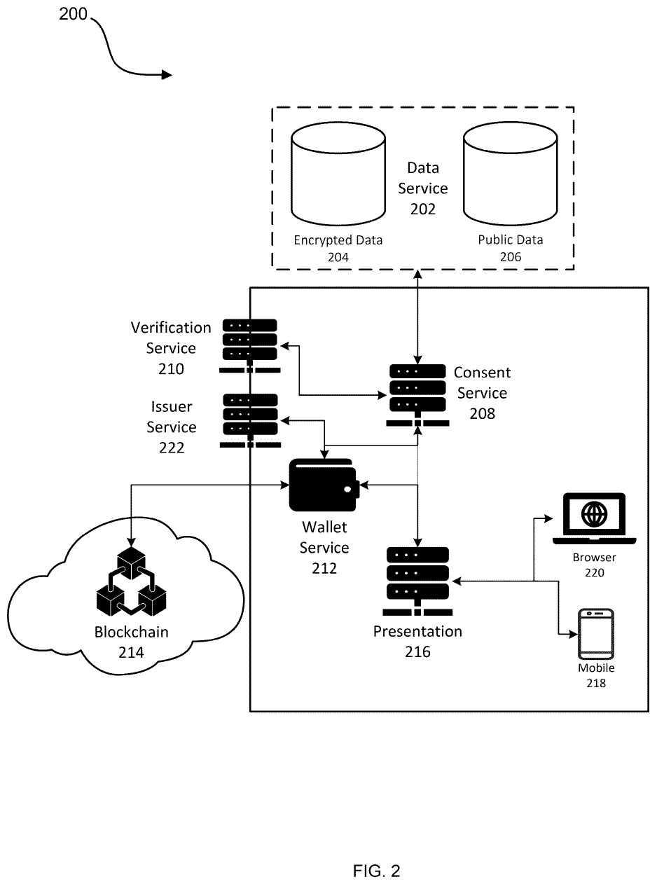

FIG. 2 illustrates an example of a DICMS system and some of the components that make up the system. The primary User or Third-Party access will be via a browser based 220 interface or a mobile app 218 interface and these will connect to the systems presentation service 216. The presentation service enables authentication and connection to the other components of the DICMS. The Wallet Service 212 leverages a decentralized infrastructure such as a blockchain 214, cryptographic network protocols, and integrates deferred cryptographic proofs and quantum-resistant encryption in issuer 222 and verification 210 services.

The consent 208 service is used to manage current and requested consent controls and to call the issuer 222 and verification 210 services as need to ensure controls and security. All access to the consent 208 service is via the presentation 216 service for all Users and Third Parties. The consent 208 service is used to control the access to data in the data service 202 and the data stores within it for encrypted data 204 and public data 206 also referred to as anonymized data in other methods.

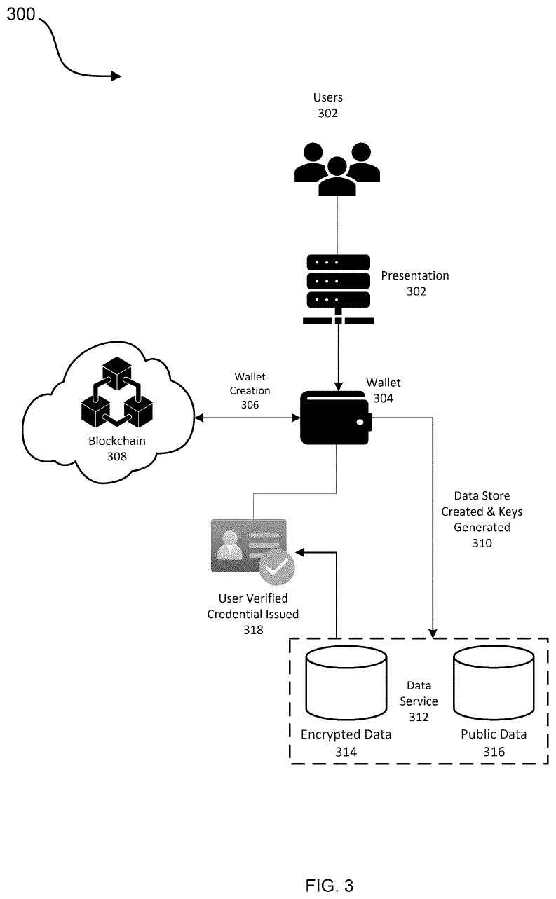

FIG. 3 illustrates components of a user's digital Identity profile creation on first access to DCIMS. When a User 302 creates a new account via the presentation 302 service using their device the wallet creation 306 process is invoked which leverages a decentralized infrastructure such as a blockchain 308 and related cryptographic services to create a User 302 a wallet 304. Once the wallet 304 is created the cryptographic service is called to generate keys 301 and invoke the data service 312 to create the encrypted 314 and public 316 data stores for the new user. Once this process is complete the User's base Verifiable Credential (VC) is issued 318 and stored in the User's 302 wallet 304.

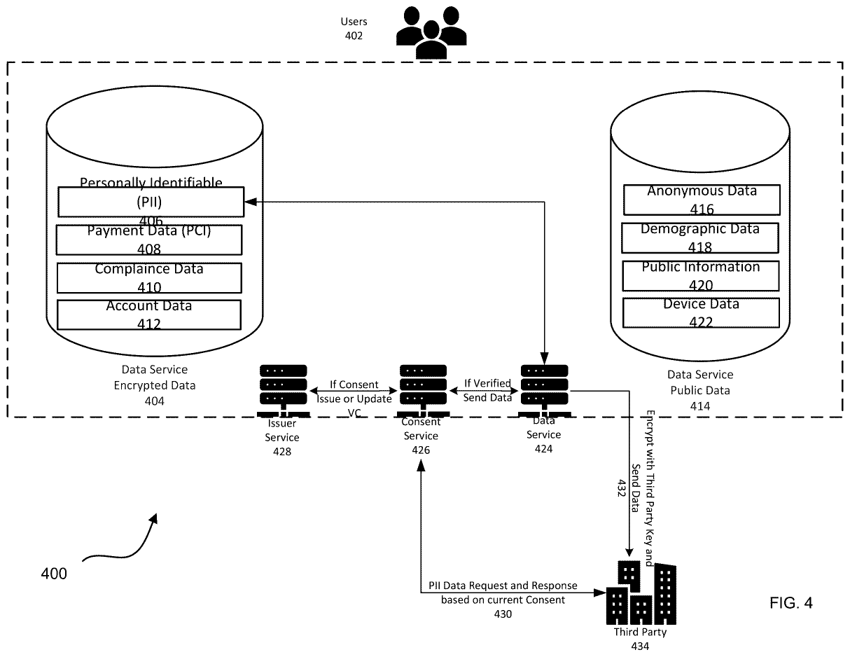

FIG. 4 illustrates an example of a user consent flow with a third-party. A User 402 has a data service 424 profile containing encrypted data 404 and public data 414. Contained within the encrypted data 404 store can be data such as Personally Identifiable Data (PII) 406 which is data that can be directly linked to a User 402. It can also contain data such as Payment data (PCI) 408 which can be linked directly to User 402 and their payment details or transaction details and related compliance data 410 as well as specific User 402 account data 412. This data is all considered personal data and is restricted to access of the User 402 and any specific data element inside of that data stored can be shared with a third-party 434 as directed by the User 402.

A User 402 also has a public data store 414 which contains anonymous 416, device data 422 and general publicly sourced data 420 and Demographic data 418 for the User 402. All User 402 data is only accessible via the Data service 424 to any party. The User 402 uses their verifiable credential in their wallet to access and a third party 434 will do the same. The Third-Party 434 will send a consent request to the User 402 via the consent service 426 to request access to the data 430 such as in this illustration from the encrypted data store 404 and elements of PII data 406. The User 402 can choose to approve or deny the consent request in bulk or specific data elements within the request 430. If the User 402 approves any part of the data consent request 430 through the consent service 426 then the Issuer service 428 will issue if new or update as need a Verifiable credential for data consent.

The Third-Party can at any point once the consent request 430 is granted request access to the data 432 that was approved by the User 402 via the Data service 424 which will verify the consent status via the Consent service 426 and then create a secure tunnel to the third-party 434 and send the data for the request 432 to the Third-Party 434 to complete the data access.

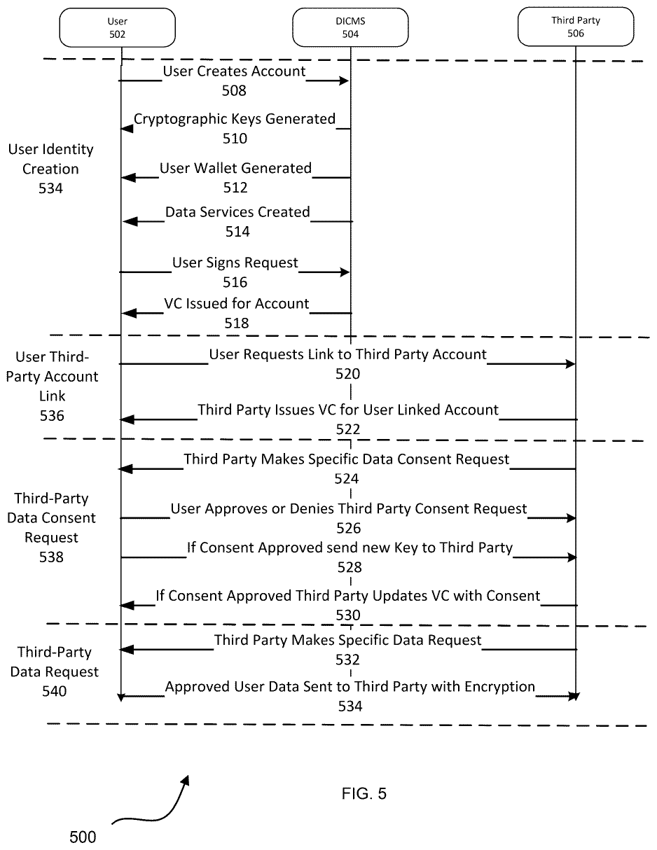

FIG. 5 illustrates some of the processes and the flow of requests from User to System and Third Parties. For the process of User Identity Creation 534 the User 502 sends an account creation request 508 to the DICMS 504 system which the creates the accounts and related cryptographic keys are generated 510. Once the required Cryptographic Keys are generated 510 then the User's 502 wallet is generated 512 and the Data Service profile is created 514 using the keys 510 stored in the Users 502 wallet 512 to secure the profile. Once this is all complete the DCIMS 504 creates a User 502 signing request for the account 516 which is sent to user 502 to be completed. Once the User 502 signs the request 516 then the issuer service of the DCIMS 504 issues a Verifiable credential (VC) for the account 518 for the User 502 to the User's wallet 512.

For the process of User 502 Third-Party 506 Account Link 536 there are two steps that are required. The User 502 via a specific request or in the normal use of a partner Third-Party 506 site can link their account through the DICMS 504 to the User's 502 profile. The User will initiate the link request 520 via the DICMS 504 to the Third-Party 506. The User 502 will then follow the process of authenticating to the Third-Party 506 site and then link via the DCIMS 504. Once the link is created the Third-Party 506 will call the DCIMS 504 issuer service to create a Verifiable Credential (VC) for the User 502 and place in wallet 512 for the linked account.

For the process of Third-Party 506 Data Consent Request 538 the Third-Party 506 will make a required or requested specific data request via the DICMS 504 to the User 502. The User 502 via the DICMS 504 will then approve or deny all or part of the Third-Party 506 specific data request 524. If any part of the specific data request is consented to the cryptographic service is called to issue update keys to the Third-Party 506 for the User 502 specific data and the Third-Party 506 updates the verifiable credential with consent via the Issuer service of DICMS 504 for the User 502 and sends to the User's wallet 512.

If a Third-Party 506 has received consent for specific data from a User 502 then the Third-Party 506 can request specific data 532 from the DICMS 504 for the User's 502 data that has previous consent. If the previous consent is verified via the Consent service of the DICMS 504 for the User 502 allowing the Third-Party 506 the specific data as request 532 then the Data service of the DICMS 504 will create an encrypted route and send 534 to Third Party 506.

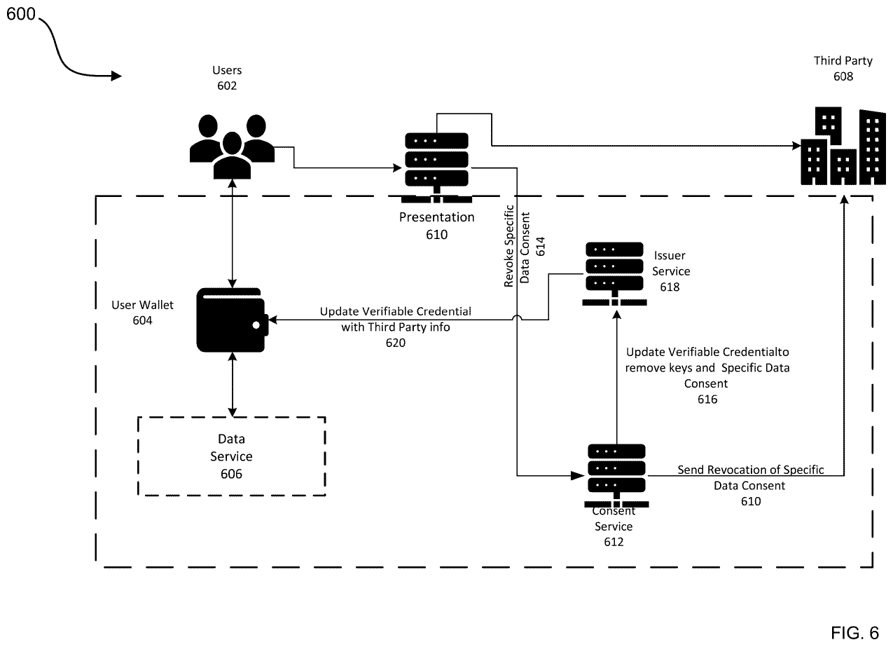

FIG. 6 illustrates third-party account data revocation flow and related services of DICMS. A User 602 takes an action to revoke access to specific data 614 that had previously been granted. This revocation of data consent 614 from some or all of User's 602 Data service 606 profile which is created in the Presentation service 610 and processed by the Consent service 612. The Consent service 612 sends a revocation request to Third-Party 608 for the specific data previously consented to. The Third-Party 608 must then handle this request via their required compliance framework which governs them. The Consent service 612 also send a request to the Issuer service 618 to update the verifiable credential (VC) with new Third-Party info 620 in the User's wallet 604. The User will then get a notification in the Presentation service 610 that the revocation process is completed. At this time the Third-Party 608 will no longer have keys to access the specific data revoked in the request 614. The User 602 can then contact the Third-Party 608 to ensure they are following whatever the required process is to remove User 602 data to comply with regulations.

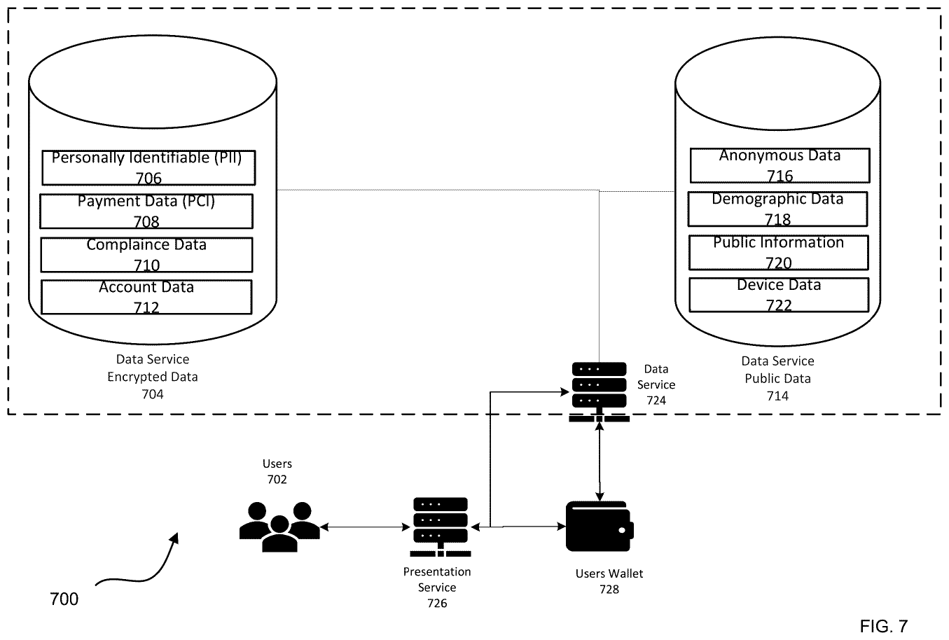

FIG. 7 illustrates User data service profile and some of the data elements under consent control. Ever User 702 has a Data service 724 profile which contains both Encrypted data 704 and Public data 714 which each contain different data elements. Contained within the encrypted data 704 store can be data such as Personally Identifiable Data (PII) 706 which is data that can be directly linked to a User 702. It can also contain data such as Payment data (PCI) 708 which can be linked directly to User 702 and their payment details or transaction details and related compliance data 710 as well as specific User 702 account data 712. This data is all considered personal data and is restricted to access of the User 702 via the keys in User Wallet 728 and any Third-Party consent grant. A User 702 also has a public data store 714 which contains anonymous 716, device data 722 and general publicly sourced data 720 and Demographic data 718 for the User 702.

All User 702 data is only accessible via the Data service 724 to any party. Third Parties will have access to User's Public Data via the Data service 724 leveraging their relationship with the DICMS platform. No access to data is provided via any other means than the Data service 724 to any parties to ensure control and traceability.

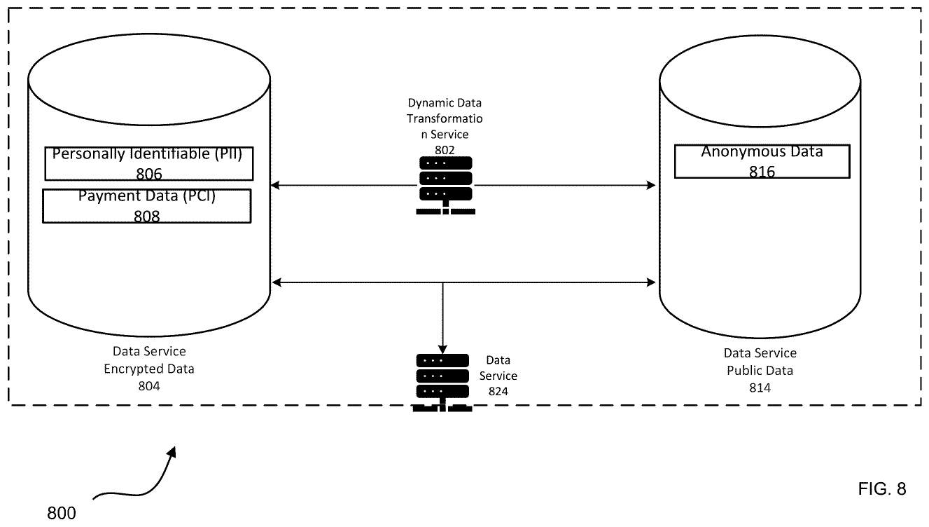

FIG. 8 illustrates the Dynamic Data Transformation Layer (DDTL) of the data service which anonymizes, normalizes, and provisions secure, compliant first-party data for third-party members. For each User data profile there is an instance of the DDTL 802 process that runs inside of the Data Service 824 and uses the Encrypted Data 804 store dataset from PII 806 and PCI 808 as the source data and populates the Public data 814 store inside the Anonymous Data 816 container with properly anonymized data. All data anonymizations done via DDLT process 802 is compliant with all global compliance standards as required by law. A User can through as with anything else not consent to the DDLT process 802 running inside their profile thru the DICMS Consent service.

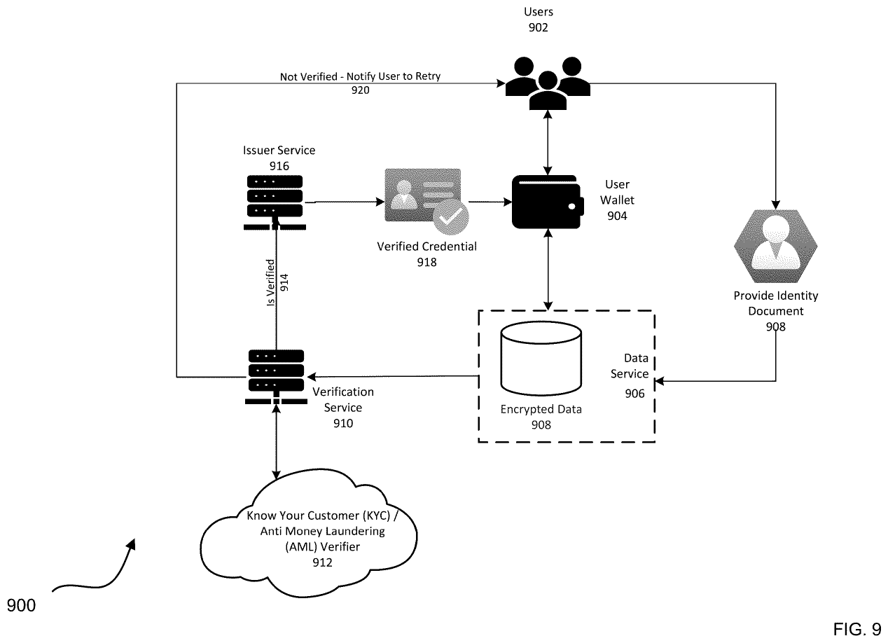

FIG. 9 illustrates the Proof of Humanity (POH) capability of the system. A User 902 may choose to at any time make their account verified via providing a government issued photo ID to the Data Service 906 to be stored in the Encrypted data 908 store of their profile. In some cases, certain Third Parties such as government entities verification may be required to receive service. Once the User 902 has provided the Government issued photo ID such as license or passport the User 902 will be sent to the Verification service 910 and linked to a licensed external vendor for KYC/AML verification 912 process. This will be performed by an external vendor which is licensed for financial institutions and government services. The external verifier 912 will send back a Is Verified 914 via the Verification service 910 or a Not Verified 920 that the User 902 will see via a notification. If the User receives an Is Verified 914 then the Issuer Service 916 will send a Verifiable Credential 918 to the User Wallet 904 and the User 902 will receive a notification.

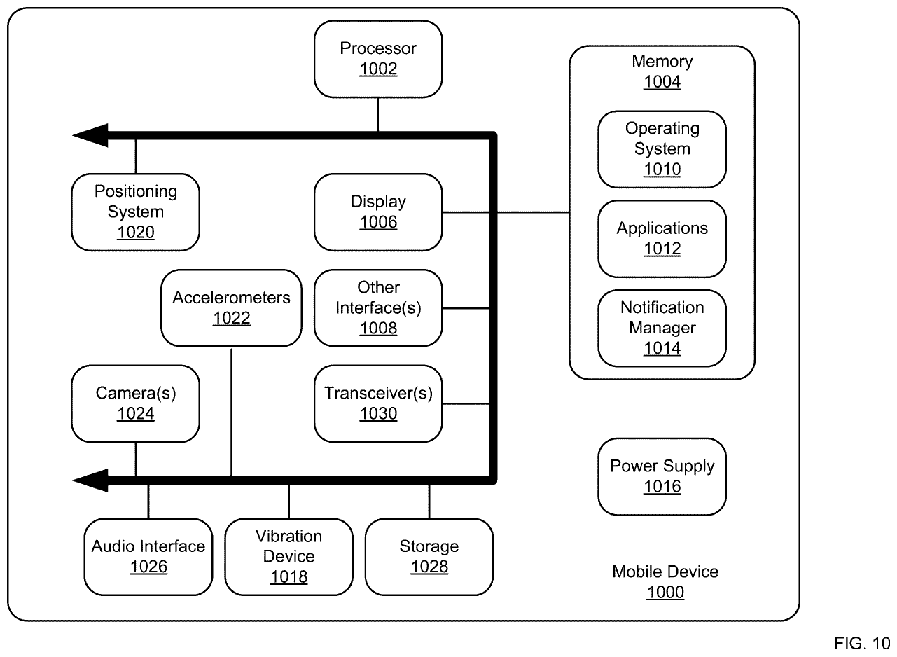

FIG. 10 illustrates another example system (labeled as a mobile device 1000) that may be useful in implementing the digital identity and consent management technology disclosed herein. The mobile device 1000 includes a processor 1002, a memory 1004, a display 1006 (e.g., a touchscreen display), and other interfaces 1008 (e.g., a keyboard) and a paired NFC tag 1009. The memory 1004 generally includes both volatile memory (e.g., RAM) and non-volatile memory (e.g., flash memory). An operating system 1010, such as the Microsoft Windows® Phone 10 operating system, the Apple OS®, Android operating system, etc., resides in the memory 1004 and is executed by the processor 1002, although it should be understood that other operating systems may be employed.

One or more application programs 1012 are loaded in the memory 1004 and executed on the operating system 1010 by the processor 1002. Examples of applications 1012 include without limitation email programs, scheduling programs, personal information managers, Internet browsing programs, multimedia player applications, etc. An implementation of the mobile device 1000 may include a mobile PCHR application for the PCHR system disclosed herein, wherein the PCHR application communicates the PCHR system implemented on a cloud server, and an NFC tag 1009 paired with the device. For example, such PCHR application may be configured to generate a GUI on the mobile device 1000 and a paired NFC tag 1009 that provides interactive capabilities to a patient using various input modalities (touch, shake, etc.).

A notification manager 1014 is also loaded in the memory 1004 and is executed by the processor 1002 to present notifications to the user. The mobile device 1000 includes a power supply 1016, which is powered by one or more batteries or other power sources, and which provides power to other components of the mobile device 1000. The power supply 1016 may also be connected to an external power source that overrides or recharges the built-in batteries or other power sources.

The mobile device 1000 includes one or more communication transceivers 1030 to provide network connectivity (e.g., mobile phone network, Wi-Fi®, BlueTooth®, etc.). The mobile device 1000 also includes various other components, such as a positioning system 1030 (e.g., a global positioning satellite transceiver), one or more accelerometers 1032, one or more cameras 1024, an audio interface 1026 (e.g., a microphone, an audio amplifier and speaker and/or audio jack), a vibration device 1018, and additional storage 1028. Other configurations may also be employed.

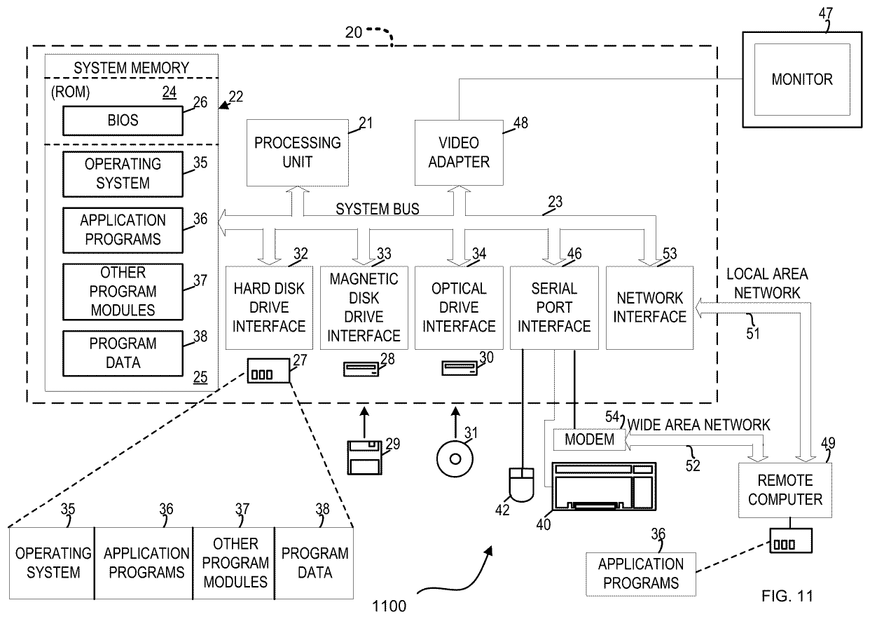

FIG. 11 illustrates an example system 1100 that may be useful in implementing the digital Identity and consent management system disclosed herein. The example hardware and operating environment of FIG. 11 for implementing the described technology includes a computing device, such as a general-purpose computing device in the form of a computer 20, a mobile telephone, a personal data assistant (PDA), a tablet, smart watch, gaming remote, or other type of computing device. In the implementation of FIG. 11, for example, the computer 20 includes a processing unit 21, a system memory 22, and a system bus 23 that operatively couples various system components, including the system memory 22 to the processing unit 21. There may be only one or there may be more than one processing units 21, such that the processor of a computer 20 comprises a single central-processing unit (CPU), or a plurality of processing units, commonly referred to as a parallel processing environment. The computer 20 may be a conventional computer, a distributed computer, or any other type of computer; the implementations are not so limited.

The system bus 23 may be any of several types of bus structures, including a memory bus or memory controller, a peripheral bus, a switched fabric, point-to-point connections, and a local bus using any of a variety of bus architectures. The system memory 22 may also be referred to as simply the memory and includes read-only memory (ROM) 24 and random-access memory (RAM) 25. A basic input/output system (BIOS) 26, contains the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The computer 20 may be used to implement the digital Identity and consent management system disclosed herein. In one implementation, one or more computer-executable instructions to implement the digital Identity and consent management system disclosed herein may be stored in memory of the computer 20, such as the read-only memory (ROM) 24 and random-access memory (RAM) 25.

Furthermore, computer-executable instructions stored on the memory of the computer 20 may be used to Implement the digital Identity and consent management system disclosed herein. Similarly, instructions stored on the memory of the computer 20 may also be used to implement one or more operations of the digital Identity and consent management system disclosed herein. The memory of the computer 20 may also one or more instructions to implement the digital Identity and consent management development system disclosed herein.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated tangible computer-readable media provide non-volatile storage of computer-readable instructions, data structures, program modules and other data for the computer 20. It should be appreciated by those skilled in the art that any type of tangible computer-readable media may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may generate reminders on the personal computer 20 through input devices such as a keyboard 40 and pointing device 42. Other input devices (not shown) may include a microphone (e.g., for voice input), a camera (e.g., for a natural user interface (NUI)), a joystick, a game pad, a satellite dish, a scanner, or the like. These and other input devices are often connected to the processing unit 21 through a serial port interface 46 that is coupled to the system bus 23, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the implementations are not limited to a particular type of communications device. The remote computer 49 may be another computer, a server, a router, a network PC, a client, a peer device, or other common network node, and typically includes many or all of the elements described above relative to the computer 20. The logical connections depicted in FIG. 11 include a local-area network (LAN) 51 and a wide-area network (WAN) 52. Such networking environments are commonplace in office networks, enterprise-wide computer networks, intranets, and the Internet, which are all types of networks.

When used in a LAN-networking environment, the computer 20 is connected to the local area network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are example and other means of communications devices for establishing a communications link between the computers may be used.

In an example implementation, software, or firmware instructions for the digital Identity and consent management development system 810 may be stored in system memory 22 and/or storage devices 29 or 31 and processed by the processing unit 21. The digital Identity and consent management development operations and data may be stored in system memory 22 and/or storage devices 29 or 31 as persistent data-stores.

In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

Some embodiments of digital Identity and consent management development system may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner, or syntax, for instructing a computer to perform a certain function. The instructions may be implemented using any suitable high-level, low-level, object-oriented, visual, compiled and/or interpreted programming language.

The digital Identity and consent management system disclosed herein may include a variety of tangible computer-readable storage media and intangible computer-readable communication signals. Tangible computer-readable storage can be embodied by any available media that can be accessed by the digital Identity and consent management system disclosed herein and includes both volatile and nonvolatile storage media, removable and non-removable storage media. Tangible computer-readable storage media excludes intangible and transitory communications signals and includes volatile and nonvolatile, removable, and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the digital Identity and consent management development system disclosed herein. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals moving through wired media such as a wired network or direct-wired connection, and signals moving through wireless media such as acoustic, RF, infrared and other wireless media.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A method for creating a user identity and related data profile the method comprising:
receiving a request to create a new user identity and related profile in the (DICMS) system the system
creating a new account via the presentation service using their hardware device to create an account and related credentials, wherein creating the new account to create the user identity comprising:
creating a user wallet using a decentralized infrastructure such as a blockchain and related cryptographic services,
using a quantum ready virtual hardware security module for self-custodial wallet creation and guaranteed ownership of wallet,
using the wallet and identity the cryptographic service is called to generate keys and invoke the data service,
using the provided keys to create the encrypted and public data stores for the new user, and
using the wallet and profile to issue the user's base Verifiable Credential (VC).

2. A method of creating an immutable, user controlled cryptographic signature to ensure consistent validation on the system which ensures that the third party can validate compliance and consent, wherein the consent is subsequently validated securely without compromising user privacy, even if the platform is audited later.

3. A system of creating a user controlled digital identity with a real-time consent capability, wherein given a user has created their profile on the DICMS system the interface for consent is available through a presentation service leveraging a browser or mobile app interface, the interface comprising:
a real-time consent interface that is completely user controlled and provides a simple and easy to use visual interface;
a consent service, comprising a hardware processor and programs, that will ensure that consent is applied to each data profile and related data element;
a consent service, comprising a hardware processor and programs, that will notify a third-party of consent revocation by a user;
a consent service, comprising a hardware processor and programs, that will notify a user of consent revocation being processed and notifications sent; and
an issuer of verifiable credentials (VC), composing a hardware processor and programs, which will issue or update a VC to user and third-party wallets within the system to issue or update consent and relationships.

4. A method for anonymizing and normalizing user data (DDLT) as a compliant first-party dataset, wherein the DDLT service comprising:
composing a hardware processor and programs, anonymizes user personal data or purchase data and normalizes it for analytics;
composing a hardware processor and programs, ensures user's identity remains protected, and all preferences are used to benefit both the user and the third-party; and
composing a hardware processor and programs, creates anonymized user data based on the personal user profile, with consent directed by user for this data use.

5. A system for user identity and consent management (DICMS) comprising:
a user digital identity and verifiable credential stored in a wallet created on a blockchain;
a user data profile stored in a secure storage location controlled by a data service;
a data service which, comprising a hardware processor and programs, which provides an interface between the users of the system and the user or third-party data profile stored within their consent control and on secure storage;
a presentation service, composing a hardware processor and programs, that provides an interface for users of the DICMS system via a browser widget, site or mobile application and connects using secure network protocols to the other services in the system;
an issuer of verifiable credentials (VC), composing a hardware processor and programs, to issue VC to user and third-party wallets within the system to create identities and relationships;
a validator service, comprising a hardware processor and programs, which will internally validate any VC issued by the issuer service and to create an interface to an external identity document validation service to interact and create a KYC/AML compliant validation and issue a use the issuer service to create a VC for the verified identity document;
a blockchain service on which to create the user identity and wallet and which provides for Nash consensus and quantum resistant environment for instant tamper proof consent validation; and
a logging service to audit usage and capabilities of the DICMS system comprising a hardware processor and programs with their resultant data stored on secure storage.
